(19) United States
(12) Patent Application Publication
(10) Pub. No.: US 2004/0262588 A1
(43) Pub. Date: Dec. 30, 2004

(54) Variable width crash cushions and end terminals

(75) Inventor: Maurice E. Bronstad, San Antonio, TX (US)

Correspondence Address: BAKER BOTTS L.L.P., 2001 ROSS AVENUE, SUITE 600, DALLAS, TX, 75201-2980, US

(73) Assignee: TRN Business Trust

(21) Appl. No.: 10/873,099

(22) Filed: Jun. 21, 2004

Related U.S. Application Data
(60) Provisional application No. 60/483,224, filed on Jun. 27, 2003.

(51) Int. Cl. A01K 3/00

(52) U.S. Cl. 256/13.1

(57) ABSTRACT

A crash cushion having a plurality of beams extending substantially parallel to one another. One end of the crash cushion slideably coupled with one end of a traffic barrier. Another end of the crash cushion faces oncoming traffic. A plurality of support post assemblies coupled to and supporting the plurality of beams. Forceful impact of a vehicle with the end of the crash cushion facing oncoming traffic will result in energy absorption during telescoping of the beams relative to the traffic barrier. A method of manufacturing crash cushions and other energy absorbing assemblies is provided.

### RELATED APPLICATION

This application claims the benefit of previously filed provisional patent application Ser. No. 60/483,224 entitled “Variable Width Crash Cushions And End Terminals” filing date Jun. 27, 2003.

This application is related to copending patent application Ser. No. 10/455,710, filing date Jun. 5, 2003, entitled “Crash Cushions And Other Energy Absorbing Devices”, now U.S. Pat. No. ______, which claims the benefit of previously filed provisional patent application Ser. No. 60/389,996 entitled “Crash Cushions And Other Energy Absorbing Devices” filing date Jun. 19, 2002.

This application is also related to copending patent application Ser. No. 10/175,366, filing date Jun. 19, 2002, entitled “Impact Assembly for an Energy Absorbing Device”, now U.S. Pat. No. ______.

### TECHNICAL FIELD OF THE INVENTION

The invention relates to energy absorbing devices which may be used along a shoulder of a roadway or a median to protect motorists from hazards such as the end of a guardrail or concrete barrier, bridge piers, abutments, sign posts and other hazards.

### BACKGROUND OF THE INVENTION

Guardrail systems are one example of traffic barriers placed along roadsides to screen errant vehicles from hazards behind the barrier. Guardrail systems are frequently constructed using steel W-beams mounted on wood or steel posts. Thrie beams may also be used to form a guardrail system. Connectors such as “Michigan end shoes” and “modified Michigan end shoes” have frequently been used to attach thrie beams and W-beams to concrete traffic barriers.

Both W-beams and thrie beams function primarily in tension to redirect an impacting vehicle. Therefore, the ends of a typical guardrail system are securely anchored to allow the associated beams to develop desired tensile forces. Since the ends of a guardrail system represent a discontinuity in the traffic barrier, the end facing oncoming traffic is subject to being struck “head-on” by vehicles with small departure angles from an adjacent roadway. When struck in this manner, the end of the guardrail may spear the vehicle. One widely used, but now obsolete, end terminal design “buried” a W-beam at the end of the guardrail facing oncoming traffic to eliminate spearing.

Various types of highway safety devices are often disposed at the end of guardrail systems and other traffic barriers. Examples include guardrail end terminals, barrels filled with sand and crash cushions. Highway agencies have used crash cushions at high accident locations for a number of years. Crash cushions are generally provided to absorb the energy of head-on impacts with decelerations that are not life threatening for design conditions. Because the number of guardrail systems is quite large and impact probability is low for the end of most guardrail systems, many states often do not have sufficient resources to employ crash cushions at the end of all guardrail systems because of the associated expense.

Development of guardrail end terminals and crash cushion designs is complicated by the need to minimize resistance to small car impacts while still providing necessary energy absorbing capability for full-size car impacts. Such impacts may occur with the end or downstream from the end of a guardrail system or other traffic barrier. U.S. Pat. No. 4,655,434 and 5,957,435 to Maurice E. Bronstad, disclose guardrail end terminals having beams with spaced openings to absorb kinetic energy of an impacting vehicle.

The use of traffic barriers and particularly concrete barriers has become more common with respect to gore areas. The terms “gore” and “gore area” may be used to describe land where two roadways diverge or converge. A gore is typically bounded on two sides by the edges of the roadways which join at the point of divergence or convergence. Traffic flow is generally in the same direction on both sides of these roadways. The gore area generally includes shoulders or marked pavement, if any, between the roadways. Additionally, a gore area may extend sixty (60) meters (approximately two hundred (200) feet) from the point of divergence or convergence.

### SUMMARY OF THE INVENTION

In accordance with teachings of the present invention disadvantages and problems associated with previous energy absorbing systems and highway safety systems have been substantially reduced or eliminated. For example energy absorbing systems such as crash cushions, often associated with concrete highway barriers and guardrail end terminals often associated with W-beam and thrie beam guardrail systems, may be formed in accordance with teachings of the present invention.

One aspect of the present invention includes an energy absorbing assembly having a pair of beams, extending substantially parallel with each other. One end of the beams may face oncoming traffic. The other end of each beam may be slidably attached to one end of a traffic barrier. A plurality of support post assemblies may be disposed between the beams. The width of the support post assemblies may be increased or decreased as required for each highway safety system.

An energy absorbing assembly incorporating teachings of the present invention may be used as a crash cushion at the end of a concrete highway barrier or as a guardrail end terminal at the end of a W-beam or thrie beam guardrail system. The energy absorbing assembly may also be installed adjacent to a gore area. Energy absorbing assemblies may be formed in accordance with teachings of the present invention to absorb kinetic energy of an impacting vehicle with optimum deceleration to protect occupants of the vehicle and prevent the vehicle from contacting an associated traffic barrier or other roadway hazard. Various types of beams may be used to form an energy absorbing assembly incorporating teachings of the present invention.

One aspect of the present invention includes a crash cushion having an upstream end with a nose assembly and an impact assembly facing oncoming traffic. The impact assembly may also be referred to as a “striker assembly” and may include an impact plate or striker plate. A plurality of breakaway support post assemblies may be disposed between the nose assembly and one end of an associated traffic barrier. A pair of cable anchor assemblies may be releasably attached to a breakaway support post assembly disposed adjacent to the nose assembly and respective energy absorbing members. The cable anchor assemblies preferably maintain desired tension on the respective energy absorbing members to resist a rail face impact between a vehicle and the associated energy absorbing member.

Technical benefits of the present invention include support post assemblies which allow varying the width of an associated energy absorbing assembly as required for each installation. Such energy absorbing assemblies may include two energy absorbing members along with an impact assembly or striker assembly and multiple support post assemblies.

For some applications, an energy absorbing assembly may be formed in accordance with teachings of the present invention using energy absorbing members having the general configuration of a thrie beam (three corrugations or crowns) or a W-beam (two corrugations or crowns) (not expressly shown). However, the present invention is not limited to use with energy absorbing members having the configuration of a thrie beam or a W-beam.

For some applications, one or more support post assemblies may be formed with a pair of breakaway posts and at least one diaphragm or spacer attached to and extending between the posts. The width of each diaphragm or spacer may vary between approximately four feet and two feet. However, diaphragms and spacers with other widths may be satisfactorily used to form an energy absorbing assembly in accordance with teachings of the present invention. For some applications a pair of diaphragms or spacers may be disposed between each pair of breakaway posts.

### BRIEF DESCRIPTION OF THE DRAWINGS

A more complete understanding of the invention and its advantages will be apparent from the following written description taken in conjunction with the accompanying drawings in which:

FIG. 1 is a schematic drawing showing an isometric view with portions broken away of a crash cushion incorporating teachings of the present invention;

FIG. 2A is a schematic drawing showing a plan view with portions broken away of the crash cushion of FIG. 1;

FIG. 2B is a schematic drawing in section taken along lines 2B-2B of FIGS. 1 and 2A;

FIG. 3 is a schematic drawing showing an isometric view of a nose cover associated with the crash cushion of FIG. 1;

FIG. 4A is a schematic drawing in elevation with portions broken away of a support post assembly incorporating teachings of the present invention;

FIG. 4B is a schematic drawing showing an isometric view of an angle associated with the support post assembly of FIG. 4A;

FIG. 4C is a schematic drawing showing an isometric view of a striker plate associated with the support post assembly of FIG. 4A;

FIG. 5 is a schematic drawing in elevation with portions broken away showing a side view of the support post assembly taken along lines 5-5 of FIG. 4A;

FIG. 6 is a schematic drawing in elevation showing satisfactory for securely engaging one end of an energy absorbing number with the support post assembly of FIG. 4A;

FIG. 7A is a schematic drawing showing an exploded, isometric view of one support post satisfactory for use with the support post assembly of FIG. 4A;

FIG. 7B is a schematic drawing in section showing a side view with portions broken away taken along lines 7B-7B of FIG. 7A;

FIG. 8 is a schematic drawing in section with portions broken away showing a connector assembly or web assembly disposed adjacent to the support post assembly of FIG. 4A;

FIG. 9A is a schematic drawing in section and in elevation with portions broken away showing a pair of cable anchor bracket assemblies and respective energy absorbing members satisfactory for use with the crash cushion of FIG. 1;

FIG. 9B is a schematic drawing showing a kick-out angle associated with the cable anchor bracket assemblies of FIG. 9A;

FIG. 9C is a schematic drawing showing an isometric view of one of the cable anchor bracket assemblies and an associated support satisfactory for use with the cable anchor of FIG. 9A;

FIG. 10A is a schematic drawing in section and in elevation with portions broken away showing another example of a support post assembly taken along lines 10A-10A of FIG. 2A;

FIG. 10B is a schematic drawing in elevation with portions broken away showing a side view of the support post assembly of FIG. 10A taken along lines 10B-10B;

FIG. 10C is a schematic drawing showing an isometric view of one example of a diaphragm or spacer satisfactory for use with a support post assembly incorporating teaching of the present invention;

FIG. 10D is a schematic drawing showing an isometric view of one example of a clip or guide which may be used to slideably couple an energy absorbing member with a support post assembly in accordance with teachings of the present invention;

FIG. 11 is a schematic drawing in section and in elevation with portions broken away showing another example of a support post assembly taken along lines 11-11 of FIG. 2A;

FIG. 12A is a schematic drawing showing an exploded, isometric view of a support post satisfactory for use with the support post assemblies of FIGS. 10A and 11;

FIG. 12B is a schematic drawing in section showing a side view with portions broken away taken along lines 12B-12B of FIG. 12A;

FIG. 13 is a schematic drawing in elevation with portions broken away showing one example of openings and lands formed in a energy absorbing member to absorb energy from a vehicle impacting with the crash cushion of FIG. 1;

FIG. 14 is a schematic drawing in elevation showing a beam connector satisfactory for slideably coupling one end of an energy absorbing member with a traffic barrier;

FIG. 15A is a first schematic drawing showing an isometric view with portions broken away of an alternative arrangement for coupling a safety system with a traffic barrier in accordance with teachings of the present invention; and

FIG. 15B is a second schematic drawing showing an isometric view with portions broken away of the alternative arrangement for coupling a safety system with a traffic barrier as shown in FIG. 15A.

### DETAILED DESCRIPTION OF THE INVENTION

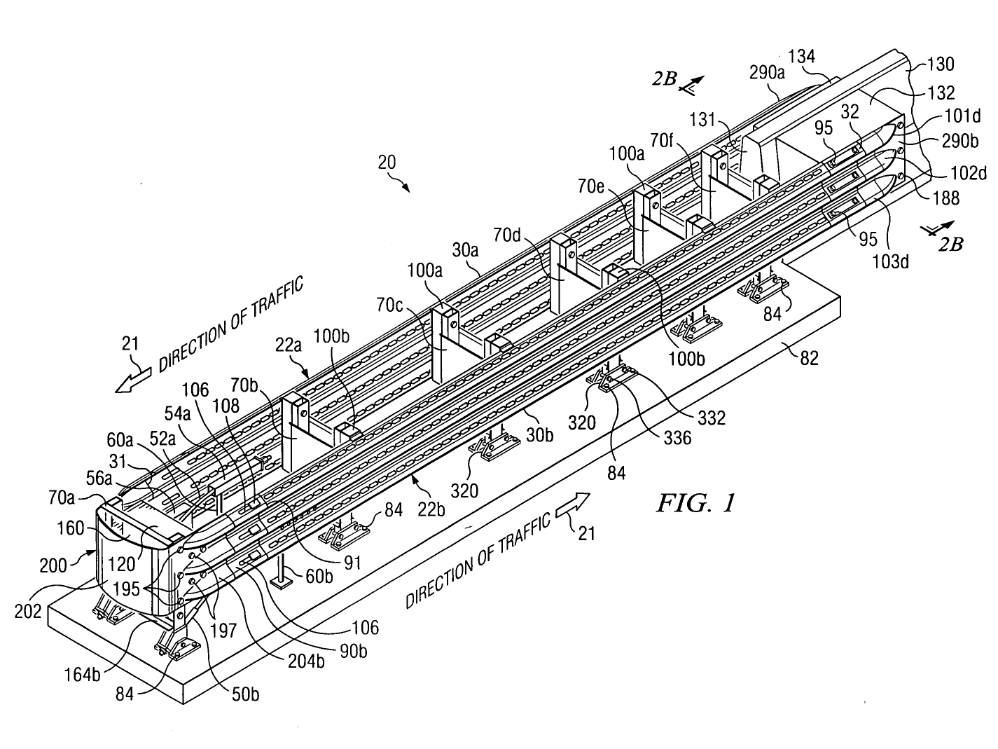

Preferred embodiments of the present invention and its advantages are best understood by referring to FIGS. 1-15B of the drawings, like numerals being used for like and corresponding parts of the various drawings.

The terms “traffic barrier” and “traffic barriers” are used in this application to include, but are not limited to, concrete highway barriers, W-beam guardrail systems, thrie beam guardrail systems, bridge abutments, retaining walls and other roadway structures and safety systems.

The terms “shredder” and “shredders” may be used in this application to include fasteners, bolts, rods, or any other device disposed adjacent to rows of lands and openings for use in dissipating kinetic energy from an impacting vehicle by shredding, ripping and/or tearing portions of an energy absorbing member.

Crash cushion 20 and associated components as shown in FIGS. 1-15B represent various examples of an energy absorbing assembly or system which may be formed in accordance with teachings of the present invention. For some applications, crash cushion 20 may be attached to end 131 of traffic barrier 130. Such applications may include off ramps (not expressly shown), lane dividers (not expressly shown), or medians in a roadway. Crash cushions and other types of energy absorbing assemblies formed in accordance with teachings of the present invention may be used with a wide variety of traffic barriers, roadway safety systems and hazard protection equipment and may be used adjacent to gore areas. The present invention is not limited to use with traffic barrier 130.

Traffic may flow in only one direction relative to crash cushion 20 and traffic barrier 130 or traffic may flow in opposite direction. For applications, such as an off ramp or lane divider, traffic may flow in the same direction adjacent to both sides of crash cushion 20 and traffic barrier 130. Arrows 21 indicate the direction of traffic flow when crash cushion 20 and barrier 130 are used in a median with traffic flow in opposing directions. Various aspects of the present invention may be described with respect to traffic flow in opposing directions relative to crash cushion 20. However, energy absorbing systems incorporating teachings of the present invention may be used with any other traffic flow patterns.

Crash cushion 20 may include nose assembly 200, energy absorbing members 30, cable anchor assemblies 50, support post assemblies 70, beam connectors 90 and 290, and other components. For purposes of describing various features of the present invention, energy absorbing members 30 have been designated 30a and 30b. Cable anchor assemblies 50 have been designated 50a and 50b. Support post assemblies 70 have been designated 70a-70f. Beam connectors 90 have been designated 90a and 90b. Beam connectors 290 have been designated 290a and 290b. Energy absorbing members 30a and 30b, cable anchor assemblies 50a and 50b, beam connectors 90a and 90b and beam connectors 290a and 290b may have substantially the same configuration and dimensions. Alternatively, each energy absorbing member, cable anchor assembly and beam connector may have different configurations and dimensions.

Crash cushion 20 may be used to prevent a vehicle (not expressly shown) from impacting with end 131 of traffic barrier 130. Crash cushion 20 is preferably capable of absorbing energy from a vehicle impact with impact assembly or striker assembly 160 while providing desired protection for occupants of the vehicle. Crash cushion 20 may also be capable of redirecting a vehicle which impacts with energy absorbing member 30a or 30b downstream from nose assembly 200, sometimes described as a “rail face” impact.

Nose assembly 200 may be attached to the first end of crash cushion 20 spaced from traffic barrier 130. For embodiments represented by crash cushion 20, nose assembly 200 includes generally curved portion 202 which covers portions of support post assembly 70a (sometimes referred to as “first support post assembly”). A reflector or traffic delineator (not expressly shown) may be included on curved portion 202. Sides 204a and 204b may be used to couple curved portion 202 with respective beam connectors 90a and 90b and adjacent portions of support post assembly 70a. Curved portion 202 and sides 204a and 204b may be formed as a single integrated unit. For other applications, curved portion 202 and side 204a and 204b may be formed as separate components which are fastened with each other to form nose assembly 200.

Nose assembly 200 may be formed from various materials which are satisfactory for wrapping around or bending around support post assembly 70a. Such materials may include, but are not limited to, rubber, plastic, elastomeric materials, recycled material, thin sheet metal, fiberglass, and/or composite materials satisfactory for use with highway safety systems.

Nose assembly 200 will generally provide only limited protection for support post assembly 70a and cable anchor assemblies 50a and 50b. For crash cushion 20, nose assembly 200 does not provide any significant energy absorbing capability during a vehicle impact. A wide variety of nose assemblies may be satisfactorily used with an energy absorbing system formed in accordance with teachings of the present invention. For some applications a nose assembly may not be necessary. The present invention is not limited to use with nose assembly 200 or any other type of nose assembly.

As shown in FIGS. 1, 2A, 15A and 15B crash cushion 20 may include a pair of beams assemblies 22a and 22b which extend from end 131 of traffic barrier 130 substantially parallel with each other and spaced laterally from each other. For embodiments represented by crash cushion 20, beam assembly 22a may include respective energy absorbing member 30a and beam connectors 90a and 290a. Beam assembly 22b may include respective energy absorbing member 30b and connectors 90b and 290b. For some applications each beam assembly 22a and 22b may include multiple energy absorbing members (not expressly shown).

Advantages of the present invention include the ability to increase or decrease the length of an energy absorbing member and increase or decrease the number of support post assemblies and longitudinal spacing between adjacent support post assemblies while maintaining desired energy absorbing characteristics. Therefore, an energy absorbing assembly may be formed in accordance with the teachings of the present invention having an overall length longer than or shorter than crash cushion 20 and having more or less support post assemblies as compared with crash cushion 20.

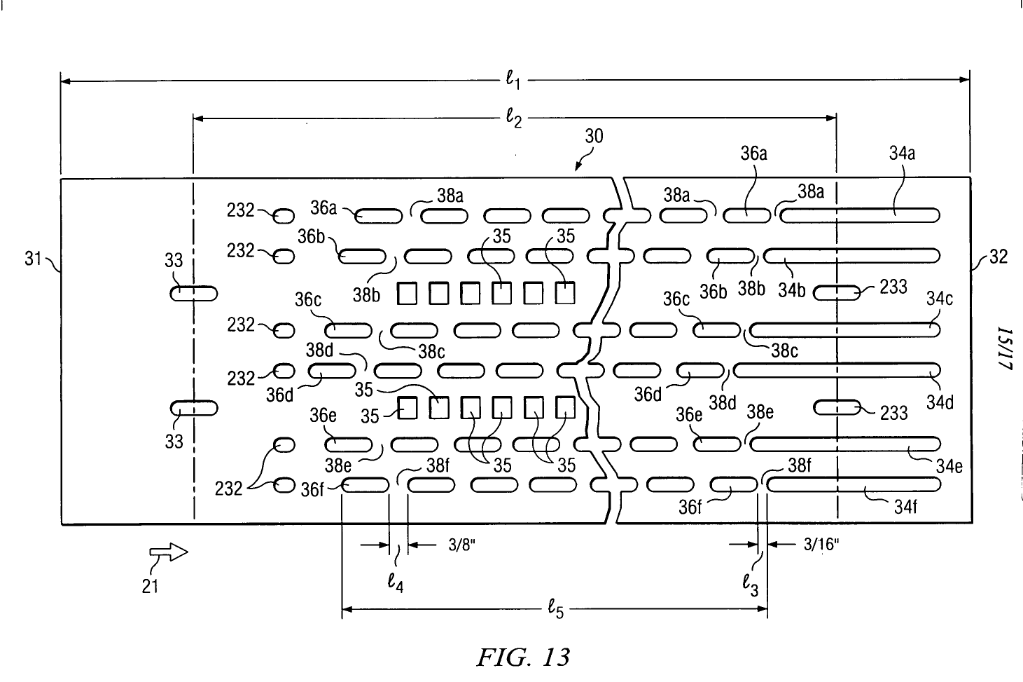

Energy absorbing members 30a and 30b may be formed with substantially the same configuration using the same materials as standard thrie beams associated with highway guardrail systems. For other applications energy absorbing members may be formed with substantially the same configuration using the same materials as standard W-beams (not expressly shown). The same general pattern of openings may be formed in each energy absorbing member as shown by energy absorbing members 30a and 30b. See FIG. 13.

For some applications energy absorbing members, which are not identical, may be used to form an energy absorbing assembly in accordance with teachings of the present invention. For example, one energy absorbing member may have the general configuration of a thrie beam and another energy absorbing member may have the general configuration of a W-beam. Also, the pattern of openings may vary between one energy absorbing member and an associated energy absorbing member.

Energy absorbing members 30a and 30b include respective first ends 31 spaced longitudinally from traffic barrier 130 and respective second ends 32 slideably coupled with traffic barrier 130. For some applications, second end 32 of energy absorbing member 30a may be slideably coupled with traffic barrier 130 proximate end 131 using beam connector 290a. Spacer block 132 may be attached to the adjacent side of traffic barrier 130 using various techniques (not expressly shown) satisfactory for use with highway safety systems. End 32 of energy absorbing member 30b may be slideably coupled with spacer block 132 using beam connector 290b.

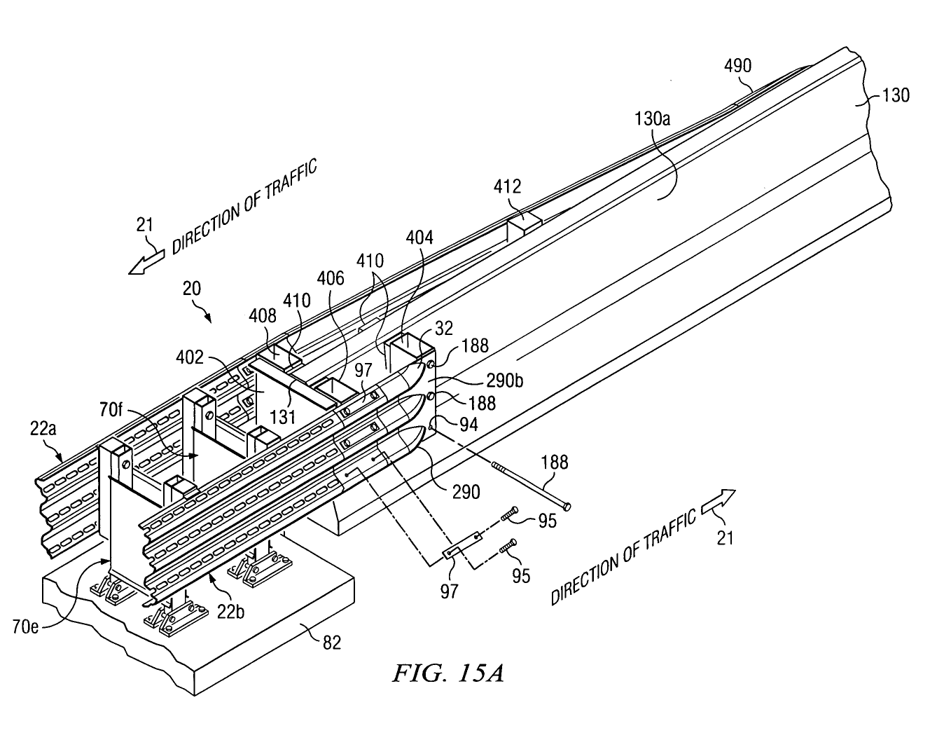

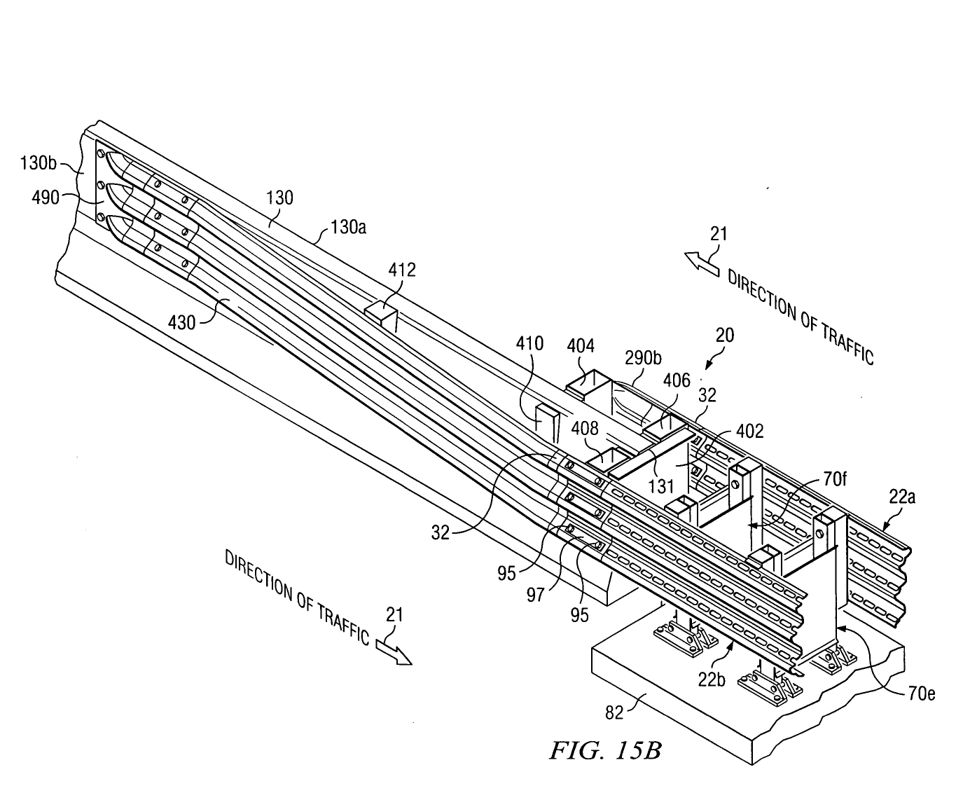

Depending on the configuration of traffic barrier 131 and the direction of adjacent traffic flow, an additional spacer block 134, may be disposed between beam connector 290a and adjacent portions of traffic barrier 130. If traffic barrier 130 and crash cushion 20 are located in a median between roadways with traffic flow in opposite directions, spacer block 134 may not be used to minimize possible snagging of a vehicle impacting with the side of traffic barrier 130. Alternatively, one or more edges of spacer block 134 may be tapered to minimize possible snagging of an impacting vehicle. FIG. 15 shows another example of coupling crash cushion 20 with traffic barrier 130 to accommodate traffic flow in opposite direction relative to traffic barrier 130.

The dimensions and configuration of spacer blocks 132 and/or 134 may be selected based on desired spacing between energy absorbing members 30a and 30b, the configuration of traffic barrier 130 and other characteristics of an associated roadway (not expressly shown) and any adjacent hazard (not expressly shown). Spacer blocks 132 and 134 are shown as being manufactured from wood. However, various types of metals, plastics, recycled materials and composite materials may be satisfactorily used to form spacer blocks 132 and 134.

FIGS. 15A and 15B show an alternative configuration and associated components for slidably engaging second ends 32 of crash cushion 20 adjacent to end 131 of traffic barrier 130.

Support post assemblies 70a-70f may be formed in accordance with teachings of the present invention to accommodate varying the width or lateral spacing between beam assemblies 22a and 22b. For some applications, the width of support posts 70a-70f may be selected to accommodate attaching respective second ends 32 of energy absorbing members 30a and 30b with the end of an associated traffic barrier without the use of spacer blocks.

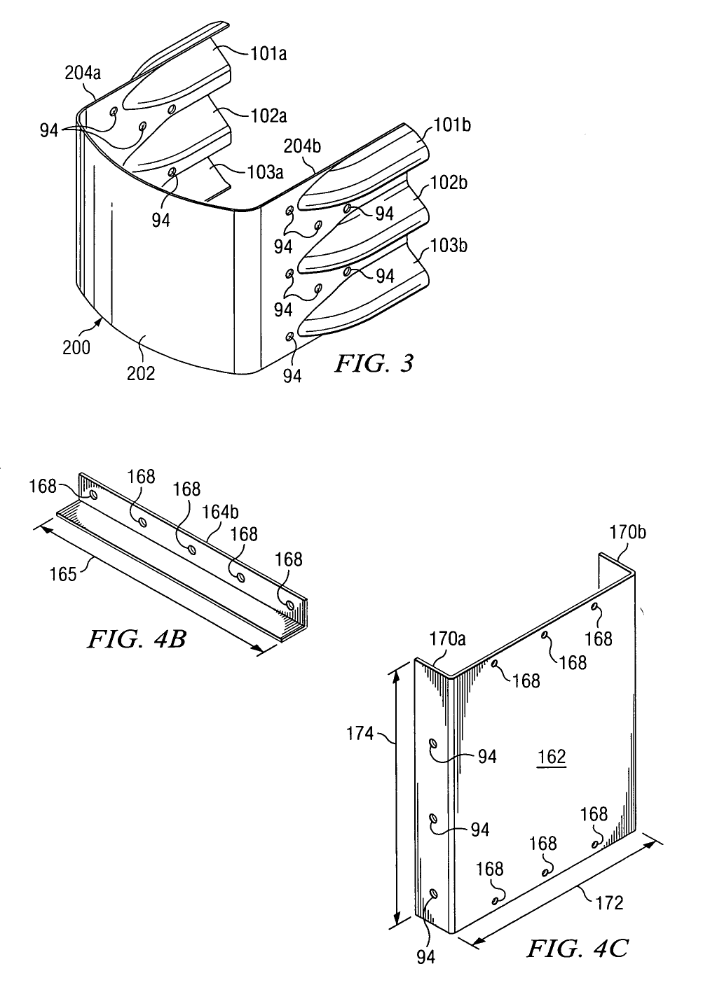

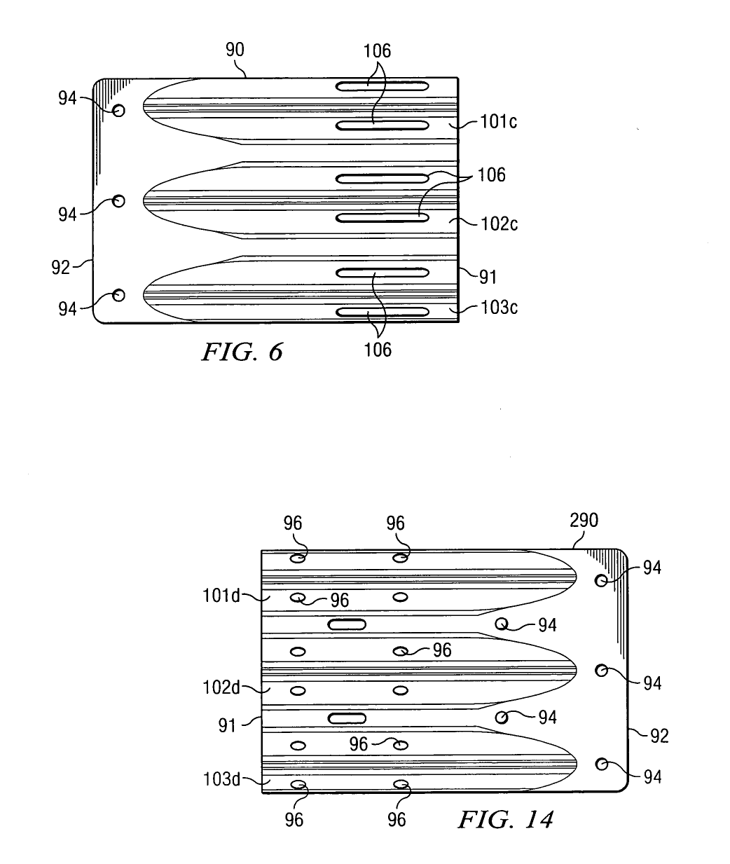

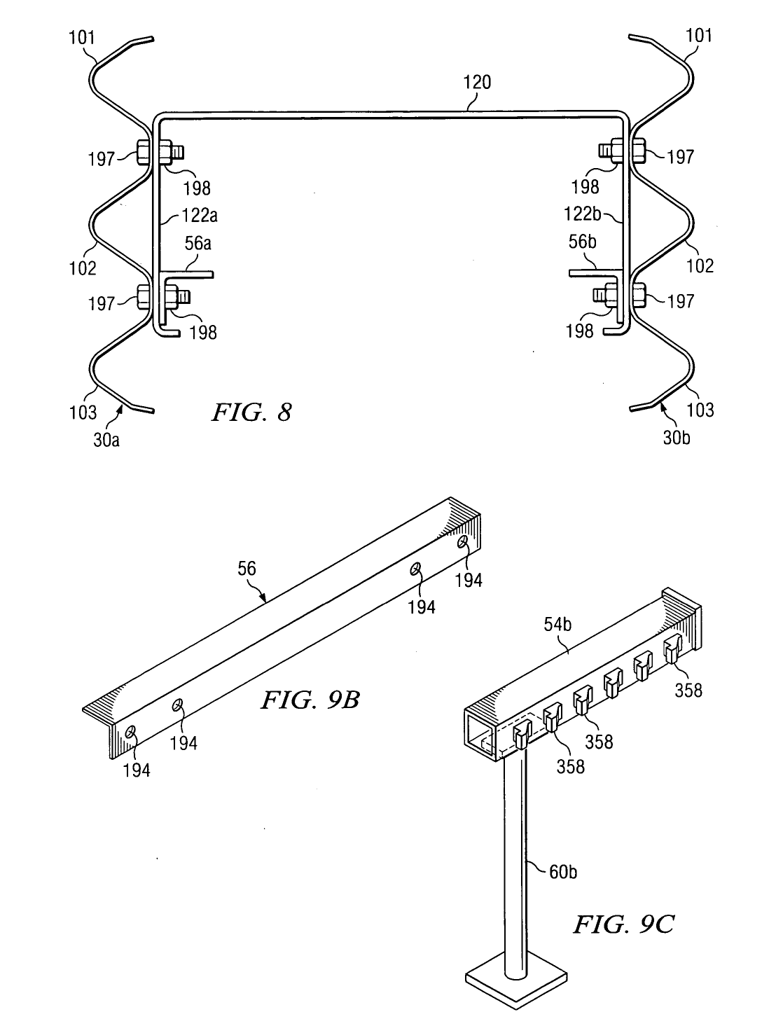

Energy absorbing members 30 may be generally described as a “modified thrie beam” which typically includes three corrugations or crowns 101, 102 and 103. See, for example, FIG. 8. Beam connectors 90 and 290 preferably include similar crown portions 101, 102 and 103. Sides 204a and 204b of nose assembly 200 may also include respective crowns 101, 102 and 103. For purposes of describing various features of the present invention, crown portions 101, 102 and 103 of side 204a have been designated 101a, 102a and 103a. Crown portions 101, 102 and 103 of side 204b have been designated 101b, 102b and 103b. Crown portions 101, 102 and 103 of beam connectors 90a and 90b have been designated as 101c, 102c and 103c. See FIGS. 3, 5 and 6. Crown portions 101, 102 and 103 of beam connectors 290a and 290b have been designated 101d, 102d and 103d. See for example FIGS. 6 and 14.

As shown in FIGS. 1, 2A, 10A and 10B energy absorbing members 30a and 30b may be coupled with and/or supported by support post assemblies 70a-70f. Support post assemblies 70a-70f may be generally described as breakaway support post assemblies. For embodiments represented by crash cushion 20, six support post assemblies may be used. For other applications, the number of support post assemblies may be varied and longitudinal spacing between adjacent support port assembling depending on the length of an associated energy absorbing system.

For some safety systems concrete foundation or concrete footing 82 may be disposed adjacent to end 131 of traffic barrier 130 extending in the direction of oncoming traffic. Bolts 84 may be disposed in concrete foundation 82 at desired locations for respective support post assemblies 70a-70f. Support post assembly 70a preferably includes a pair of posts 75a and 75b. Posts 75a and 75b may include respective base plate assemblies 76a and 76b. Each support post assembly 70b-70f preferably includes a pair of posts 77a and 77b. Each post 77a and 77b may include respective base plate assemblies 78a and 78b. As discussed later in more detail, base plate assemblies 76 and 78 may be formed from multiple components.

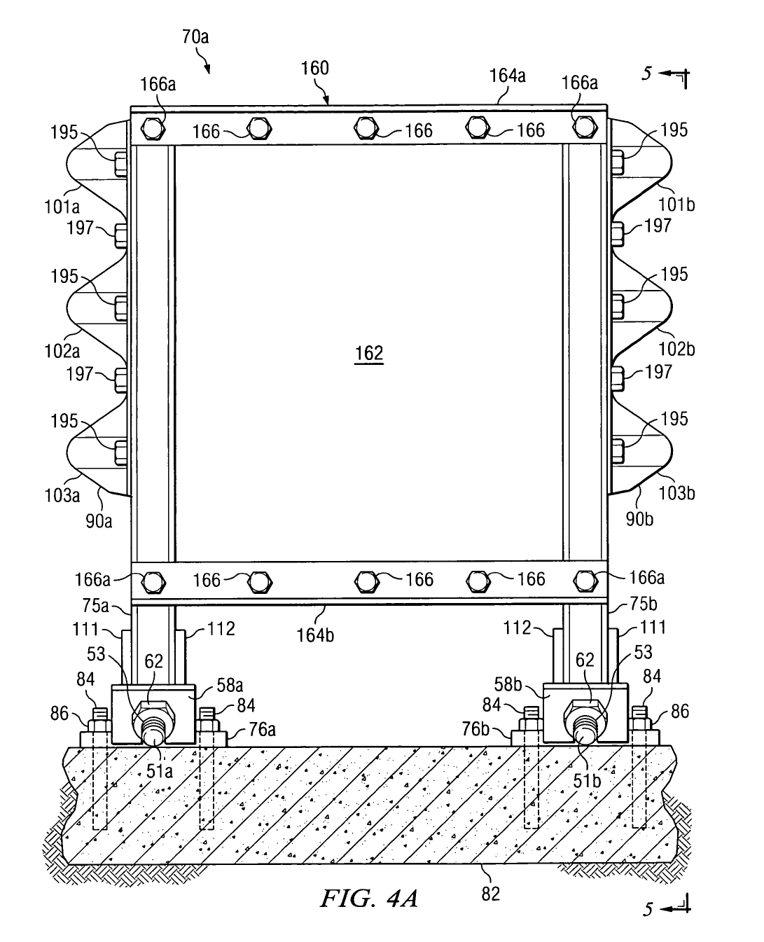

Respective nuts 86 may be used to secure base plate assemblies 76 and 78 with bolts 84. See FIGS. 4A, 5, 10A and 10B. Various types of mechanical fasteners other than bolts 84 and nuts 86 may be satisfactorily used to secure base plate assemblies 76 and 78 with concrete foundation 82. The present invention is not limited to use with concrete foundation 82, bolts 84, nuts 86, or base plate assemblies 76 and 78.

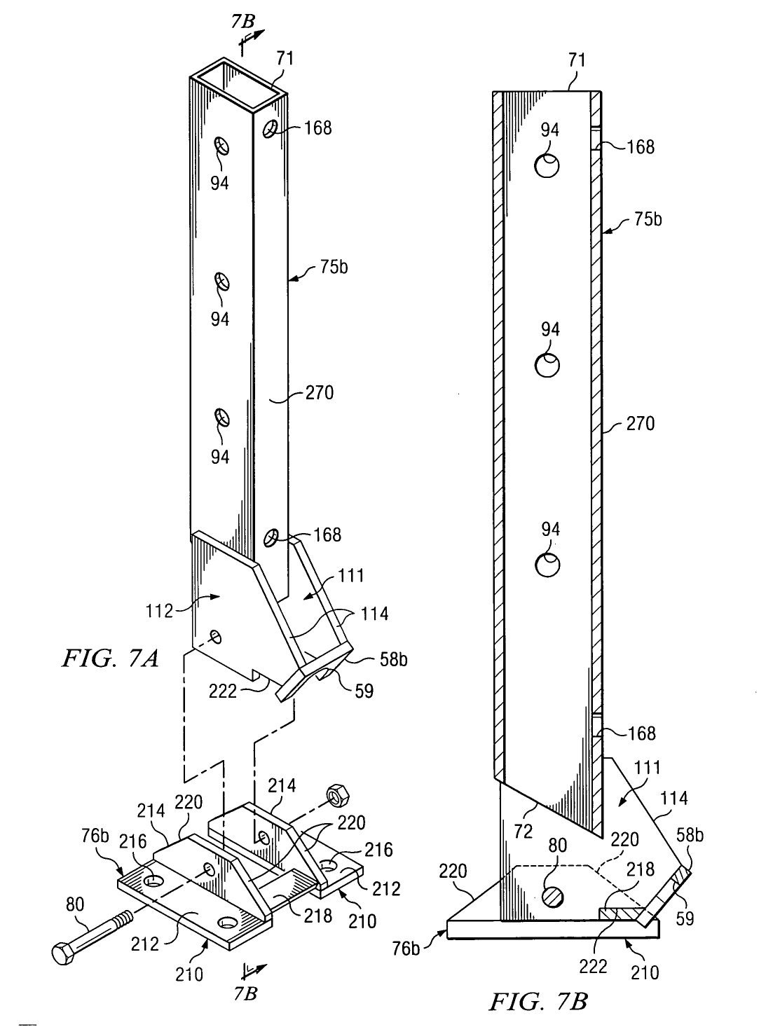

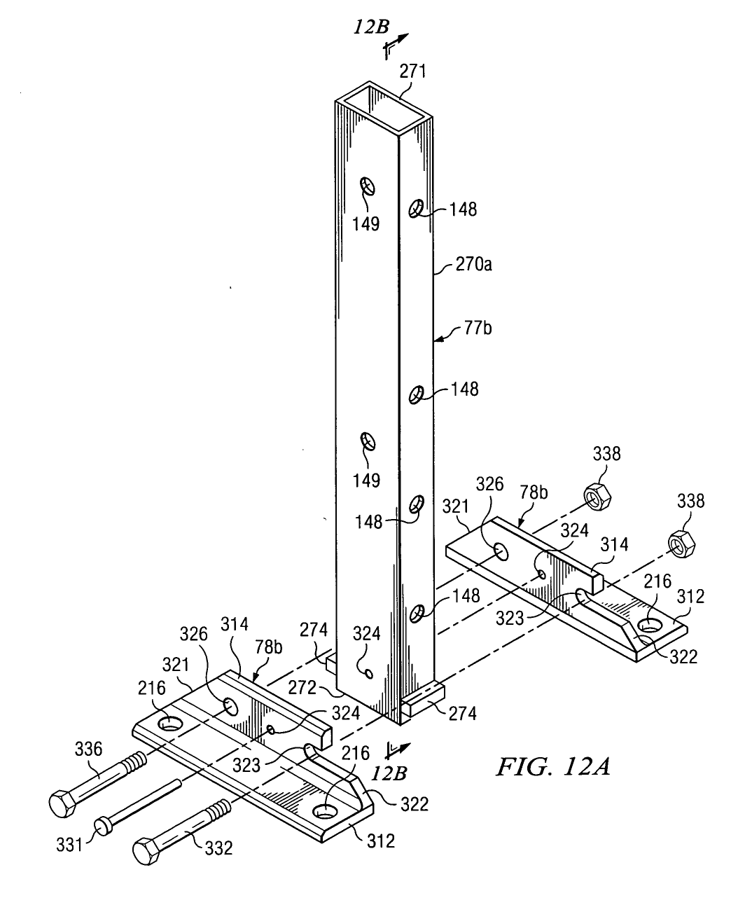

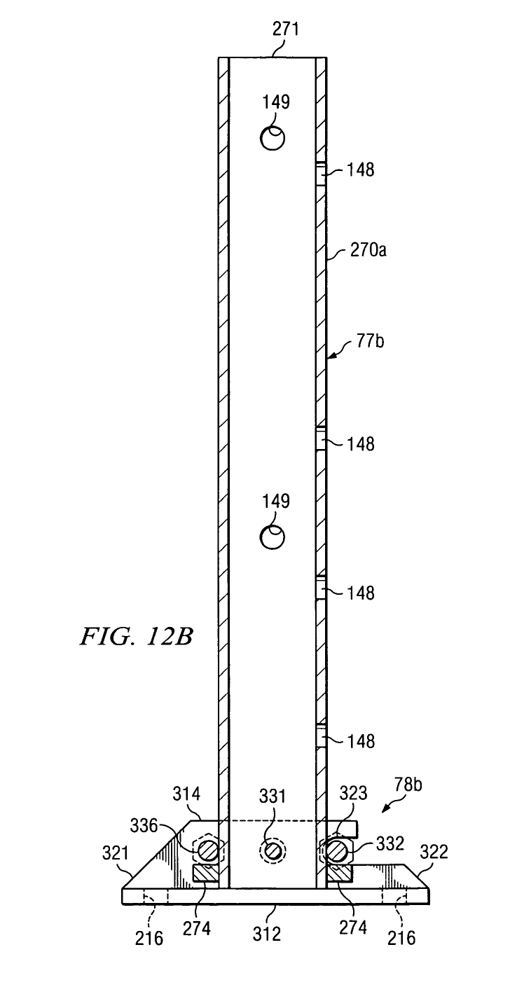

For some embodiments, support posts 75a and 75b may have approximately the same dimensions and configuration. Support post 75b is shown in more detail in FIG. 7A and 7B. For some embodiments, support posts 77a and 77b may have approximately the same dimensions and configuration. Support post 77b is shown in more detail in FIGS. 12A and 12B. For some applications supports posts 75a, 75b, 77a and 77b may be formed from commercially available tubular products having a generally hollow, rectangular cross section.

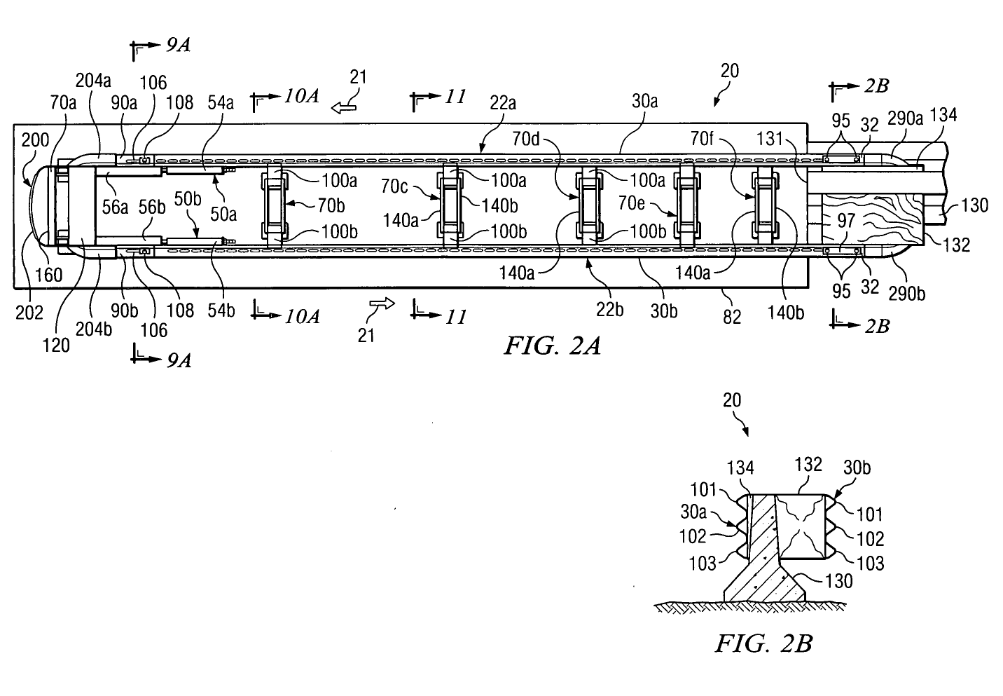

Beam connector 90 of FIG. 6 may be satisfactorily used as beam connectors 90a and 90b shown in FIGS. 1 and 2A. Beam connector 290 of FIG. 14 may be satisfactory for use as beam connectors 290a and 290b shown in FIGS. 1 and 2A. Beam connectors 90 and 290 may have similar overall configurations and dimensions. Beam connectors 90a and 90b may be modified for secure attachment with first support post assembly 70a and modified for limited longitudinal movement relative to first ends 31 of energy absorbing members 30a and 30b. Beam connectors 290a and 290b may be modified for secure attachment with associated traffic barrier 130 and modified to allow longitudinal sliding of respective energy absorbing members 30a and 30b relative thereto.

Beam connectors 90a, 90b, 290a and 290b may have a general configuration compatible with a thrie beam. Such beam connectors may sometimes be referred to “modified Michigan end shoes”. However, other types of beam connectors may be satisfactorily used to attach the first end of an energy absorbing member with a support post assembly and the second end of the energy absorbing member with a traffic barrier in accordance with teachings of the present invention. The present invention is not limited to use with beam connectors 90a, 90b, 290a and 290b.

Referring to FIGS. 4A, 5 and 6, beam connectors 90a and 90b may be securely attached to opposite sides of support post assembly 70a. Beam connectors 90a and 90b may be slideably attached to respective first ends 31 of energy absorbing members 30a and 30b. A plurality of holes or openings 94 may be formed adjacent to second end 92 of each beam connector 90. Respective holes or openings 94 may also be formed in sides 204a and 204b of nose assembly 200. The dimensions and configuration of holes 94 in beam connectors 90a and 90b preferably match with the dimension and configuration of holes 94 in respective sides 204a and 204b.

A plurality of bolts 195 may be inserted through corresponding holes 94 to securely engage side 204a of nose assembly 200 and beam connector 90a with post 75a of support post assembly 70a. A plurality bolts 195 may also be inserted through respective holes 94 to securely engage side 204b of nose assembly 200 and beam connector 90b with post 75b of support post assembly 70a. See FIGS. 1, 4A and 5. As discussed later with respect to FIG. 8, respective bolts 197 may be inserted through corresponding holes 94 to securely engage side 204a of nose assembly 200 and beam connector 90a with side 122a of web plate 120. Respective bolts 197 may also be inserted through respective holes 94 to securely engage side 204b of nose assembly 200 and beam connector 90b with side 122b of web plate 120.

Respective first ends 91 of beam connectors 90a and 90b preferably extends from support post assembly 70a towards associated traffic barrier 130. Crown portions 101c, 102c and 103c are preferably formed in first end 91 and extend towards second end 92. A plurality of slots 106 may be formed in each side of crowns 101c, 102c and 103c. Ends 31 of energy absorbing members 30a and 30b may be respectively disposed within crown portions 101c, 102c and 103c of beam connectors 90a and 90b. Bolts 108 or other suitable mechanical fasteners preferably extend through each slot 106 and respective holes 232 formed adjacent to first end 31 of each energy absorbing member 30a and 30b. See FIGS. 1, 6 and 13. During a vehicle collision with impact assembly 160, slots 106 and fasteners 108 cooperate with each other to allow nose assembly 200, support post assembly 70a, impact assembly 160, and beam connectors 90a and 90b to move longitudinally or slide relative to energy absorbing members 30a and 30b until cable anchor assemblies 50a and 50b have been disengaged from respective energy absorbing members 30a and 30b.

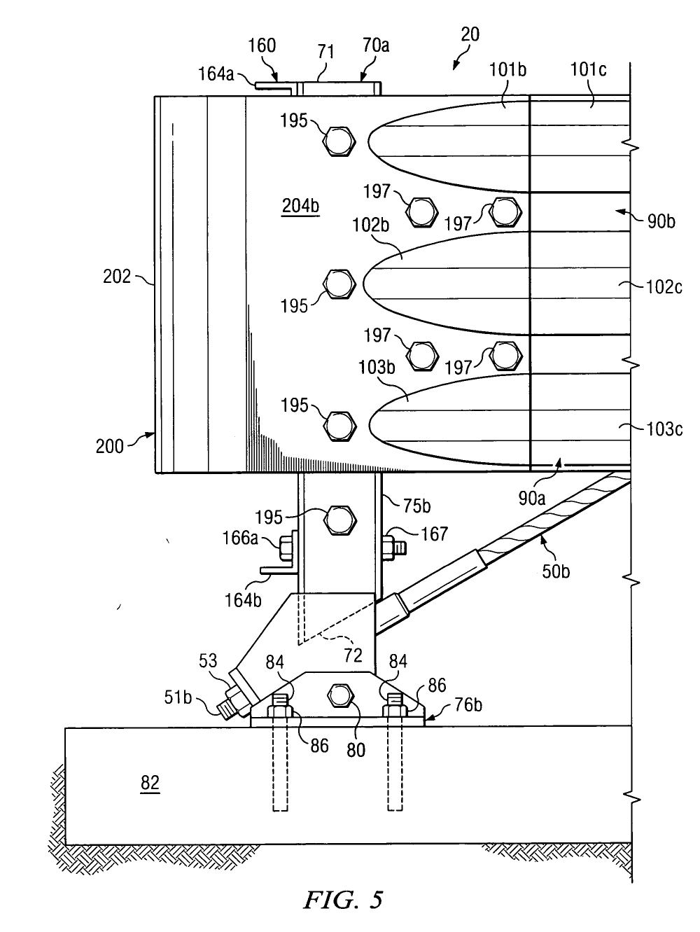

Impact assembly 160 as shown in FIGS. 4A, 4B, 4C and 5 may also be securely attached to and from a portion of support post assembly 70a. For some applications, impact assembly 160 may include striker plate or impact plate 162, a pair of angles 164a, 164b and associated bolts 166, 166a and 195 or other suitable mechanical fasteners. For the embodiment shown in FIGS. 4A and 4B, angles 164a and 164b may have approximately the same dimensions and configurations. Alternatively, the dimensions and configuration of angles 164a and/or 164b may be modified to accommodate installation at various roadside hazards.

A plurality of holes 168 are preferably formed in angles 164a, 164b and corresponding portions of striker plate 162 to accommodate bolts 166 and 166a. Similar holes 168 may also be formed in support posts 75a and 75b to accommodate installation of respective bolt 166a. Bolts 166a disposed at respective corners of impact assembly 160 may be longer than bolts 166. Respective nuts 167 may be used to securely engage bolts 166 and 166a with respective posts 75a, 75b and impact plate 162. See FIGS. 5 and 7B.

For the embodiment shown in FIG. 4C, impact plate 162 may be described as having a generally U-shaped cross-section defined in part by respective sides 170a and 170b. A plurality of holes 94 are preferably formed in each side 170a and 170b to accommodate installation of bolts 195 or other suitable mechanical fasteners which may be used to securely attach nose assembly 200 and beam connectors 90a and 90b with impact assembly 160 and support post assembly 70a. A plurality of holes 94 may also be formed in the side of each post 75a and 75b to accommodate installation of respective bolts 195. See FIGS. 4A and 7A.

Width 172 of striker plate 162 is preferably selected to correspond with desired lateral spacing between energy absorbing members 30a and 30b. Height 174 and the location of respective holes 94 in sides 170a and 170b and posts 75a and 75b are preferably selected to position impact assembly 160 to accommodate a collision or impact between the side of a vehicle and the end of crash cushion 20 facing on-coming traffic. For some installations angle 164b will preferably be positioned at an appropriate distance above foundation 82 such that the side frame of an impacting vehicle will engage or contact striker plate 162 during a side impact.

Many vehicles on today's highways are reasonably configured for a head-on impact with a conventional highway energy absorbing assembly or crash cushion. The bumper, engine and/or engine compartment generally provide adequate structure for engagement with the end of a conventional energy absorbing assembly facing oncoming traffic to allow desired energy absorption without unduly damaging or impinging upon the passenger compartment. During most head-on collisions or impacts with the end of crash cushion 20 spaced from an associated highway barrier or other traffic hazard, energy will be transferred from an impacting vehicle to impact assembly 160, support post assembly 70a and energy absorbing members 30a and 30b.

Other vehicles currently in use on today's highways may have only a minimal structure along the sides of the vehicles. Also, some vehicles may have a relatively low front bumper profile, which may not satisfactorily engage posts 75a and 75b and attached energy absorbing members 30a and 30b. Therefore, height 174 of plate 162 may be increased and/or the location of angle 164b lowered to provide satisfactory engagement to transfer energy from a floor structure of a vehicle during a side impact with the end of crash cushion 20 facing oncoming traffic. Impact assembly 160 may also assist with transferring energy when a vehicle having a low front bumper profile during head on impacts with the end of crash cushion 20 facing oncoming traffic.

Various types of mechanical fasteners and/or welds may be satisfactorily used to attach an impact assembly with energy absorbing assembly formed in accordance with teachings of the present invention. The present invention is not limited to use with bolts 166, 166a, 195 and nuts 167. Striker plate 162 may also be attached with support post assembly 70a using welding techniques and/or other mechanical fasteners as desired.

Energy absorbing members 30a and 30b may be slideably coupled with one or more support post assemblies 70b-70f to facilitate telescoping movement of energy absorbing members 30a and 30b relative to support post assemblies 70b-70f and traffic barrier 130 during a vehicle collision with impact assembly 160. Support post assembly 70a will preferably breakaway to release tension associated with anchor cable assemblies 50a and 50b when a vehicle collides with impact assembly 160. Depending upon the force or kinetic energy associated with an impacting vehicle, support post assemblies 70b-70f may also breakaway or collapse allowing energy absorbing members 30a and 30b to telescope relative to traffic barrier 130. The kinetic energy of an impacting vehicle will determine the number of posts assemblies 70a-70f which are broken away and the amount of telescoping of energy absorbing members 30a and 30b relative to first end 131 of traffic barrier 130. Longitudinal spacing between support post assemblies 70a-70f may be varied to provide increased resistance to rail face impacts adjacent to traffic barrier 130.

Support posts 75a and 75b may include respective rectangular hollow tubes 270 formed from steel alloys or other materials associated with highway safety systems. Hollow tubes 270 include respective first end 71 and second end 72. Holes 94 are preferably formed in both sides of hollow tube 270 to accommodate installation of respective bolts 95 and corresponding nuts (not expressly shown). Respective holes 168 may be formed along each edge of hollow tubes 270 to accommodate installation of respective bolts 166a and nuts 167.

Support posts 75a and 75b may be releasably engaged with respective base plates 76a and 76b. A pair of vertical support plates 111 and 112 may be used to securely attach second end 72 of each hollow tube 270 with respective base plates 76a and 76b. Respective shear bolts 80 may be used to releasably attach vertical support plates 111 and 112 with respective base plates 76a and 76b. Support plates 111 and 112 and base plates 76a and 76b cooperate with each other to allow support post assembly 70a to resist a rail face impact and to breakaway during a vehicle collision with impact assembly 160.

For the embodiment shown in FIGS. 7A and 7B, support plates 111 and 112 may have a modified rectangular configuration with respective tapered edge 114 to accommodate respective cable support plates 58a and 58b. As discussed later in more detail, each cable support plate 58a and 58b preferably includes respective openings 59 to accommodate engagement with one end of respective cable anchor assemblies 50a and 50b. The second end 72 of each hollow tube 270 may be securely attached with respective vertical support plates 111 and 112 using various welding techniques and/or other bonding techniques associated with highway safety systems.

As shown in FIGS. 5, 7A and 7B vertical support plates 111 and 112 may be preferably releasably engaged with respective foot plate assemblies 76a and 76b. Foot plate assemblies 76a and 76b preferably include a pair of angles 210 which are joined with each other by connector 218. Each angle 210 preferably includes horizontal segment 212 and vertical segment 214. Horizontal segments 212 preferably include holes 216 which are sized to receive bolts 84. Vertical segments 214 preferably include tapered edges 220. The dimensions and configuration of tapered edges 220 are preferably selected to minimize snagging when a vehicle collides with impact plate 160. Each vertical support plate 111 and 112 preferably includes respective notch 222 sized to accommodate connector 218.

When support post 75b is releasably engaged with base plate or foot plate 76b, cable support plate 58b will engage connector 218 to transfer tension or force from respective cable anchor assembly 50b to bolts 84 and foundation 82. During a collision between a vehicle and impact plate 160, impact will initially cause rotation of posts 75a and 75b relative to bolts 80. U-shaped openings 59 formed in each bearing plate 58a and 58b will allow disengagements from respective connectors 218. Rotation of post 76a and 76b upon impact by a vehicle will allow release of respective cable anchor assemblies 50a and 50b from U-shaped openings 59. With the release of cable anchor assemblies 50a and 50b, bolts 80 will preferably shear to release support post 75a and 75b from their respective base plates 76a and 76b.

Cable anchor assemblies 50a and 50b may include various components such as respective cables 52a and 52b and cable anchor brackets 54a and 54b. Kick-out angles 56a and 56b may also be attached to respective sides 122a and 122b of web plate 120. See FIGS. 2A, 5, 8, 9A and 9B. For some applications, kick-out angles 56a and 56b may not be required. Various types of cables such as wire rope may be used to form a cable anchor assembly satisfactory for use with the present invention.

Cable anchor assemblies 50a and 50b include respective threaded bolts 56 provided at first ends 51a and 51b of cables 52a and 52b. Respective reinforcing plates or support plates 58a and 58b are preferably disposed on posts 75a and 75b adjacent to base plates 76a and 76b. Openings 59 are preferably placed in reinforcing plates 58a and 58b. See FIGS. 7A and 7B. Ends 51a and 51b of cable anchor assemblies 50a and 50b may be attached with posts 75a and 75b by inserting respective bolts 53 through corresponding openings 59 in reinforcing plates 58a and 58b. Respective nuts 62 may be used to secure bolts 53 and associated cable anchor assemblies 50a and 50b with posts 75a and 75b. Various types of mechanical fasteners may be satisfactorily used to attach cable anchor assemblies 50a and 50b with support post assembly 71a. The present invention is not limited to use with bolts 53 and nuts 62.

First ends 51a and 51b of respective cables 52a and 52b may be releasably secured proximate the ground line or surface of concrete foundation 82 at the first end of crash cushion 20. See FIGS. 4A and 5. Second end 72 of each hollow tube 270 is preferably cut at an angle corresponding approximately with respective angles formed between cables 52a and 52b and concrete foundation or footing 82. The first end of cables 52a and 52b may be releasably secured proximate the ground line using mechanisms other than first post assembly 70a.

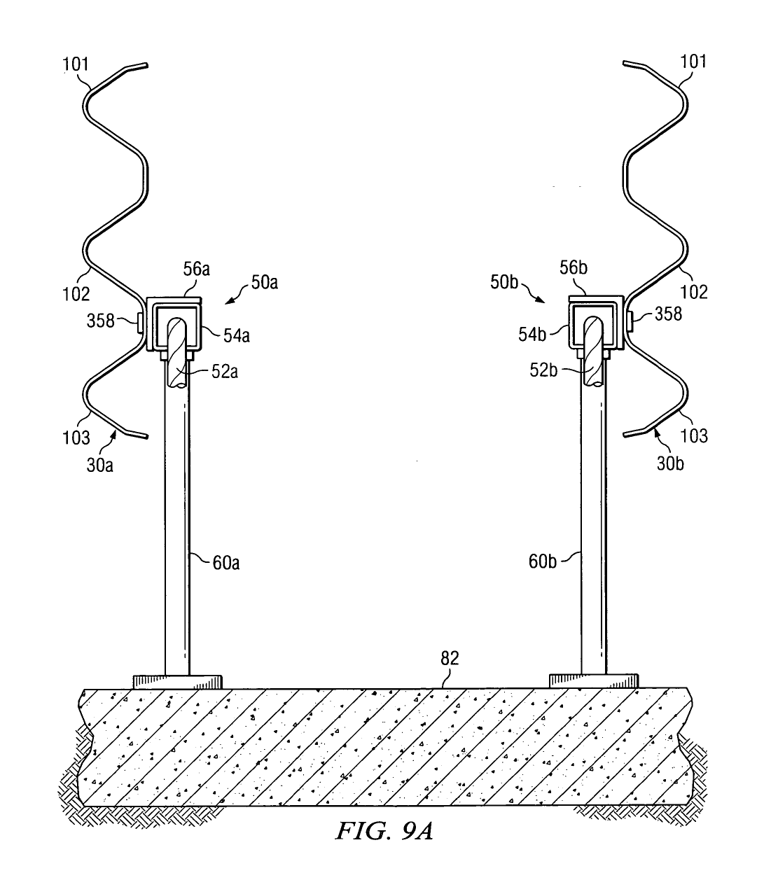

The second end of each cable 52a and 52b may be attached to respective cable anchor brackets 54a and 54b. Cable anchor brackets 54a and 54b may be releasably engaged with respective energy absorbing member 30a and 30b. For some applications, each cable anchor bracket 54a and 54b may include a plurality of lugs 58 which engage respective opens 35 in respective energy absorbing member 30a and 30b. See FIGS. 9C and 12. Posts 60a and 60b may also be provided to maintain respective cable anchor brackets 54a and 54b securely engaged with energy absorbing members 30a and 30b. For some applications, an energy absorbing assembly may be formed in accordance with teachings of the present invention without the use of posts 60a and 60b.

Cable anchor assemblies 50a and 50b provide sufficient tension to allow respective energy absorbing members 30a and 30b to withstand a rail face impact between nose assembly 200 and traffic barrier 130. A vehicle colliding with impact assembly 160 will cause support post assembly 70a to breakaway and release tension associated with cable anchor assemblies 50a and 50b. Cable anchor brackets 54a and 54b may be disengaged from respective energy absorbing members 30a and 30b by kick-out angles 56a and 56b pushing against respective cable anchor brackets 54a and 54b when a vehicle collides with impact assembly 160.

For some applications web plate assembly 120 as shown in FIGS. 1, 2A and 8 may be securely engaged with energy absorbing members 30a and 30b adjacent to support post assembly 70a. For the embodiment shown in FIG. 8 web plate assembly 120 may be securely engaged with beam connectors 90a and 90b by a plurality of bolts 197 and nuts 198. Holes 194 may be formed in each kick-out angle 56a and 56b to accommodate bolts 197 and secure engagement of kick-out angles 56a and 56b with beam connectors 90a and 90b. As previously discussed slots 106 and mechanical fasteners 108 allow limited longitudinal movement of impact plate assembly 160 and support post assembly 70a longitudinally relative to energy absorbing members 30a and 30b. The limited movement allows kick-out angles 56a and 56b to disengage respective cable anchor brackets 54a and 54b from respective energy absorbing members 30a and 30b. After cable anchor brackets 54a and 54b have been engaged, impact assembly 160 and first support post assembly 70a will engage first ends 31 of energy absorbing members 30a and 30b to move energy absorbing members 30a and 30b longitudinally relative to end 131 of highway traffic barrier 130.

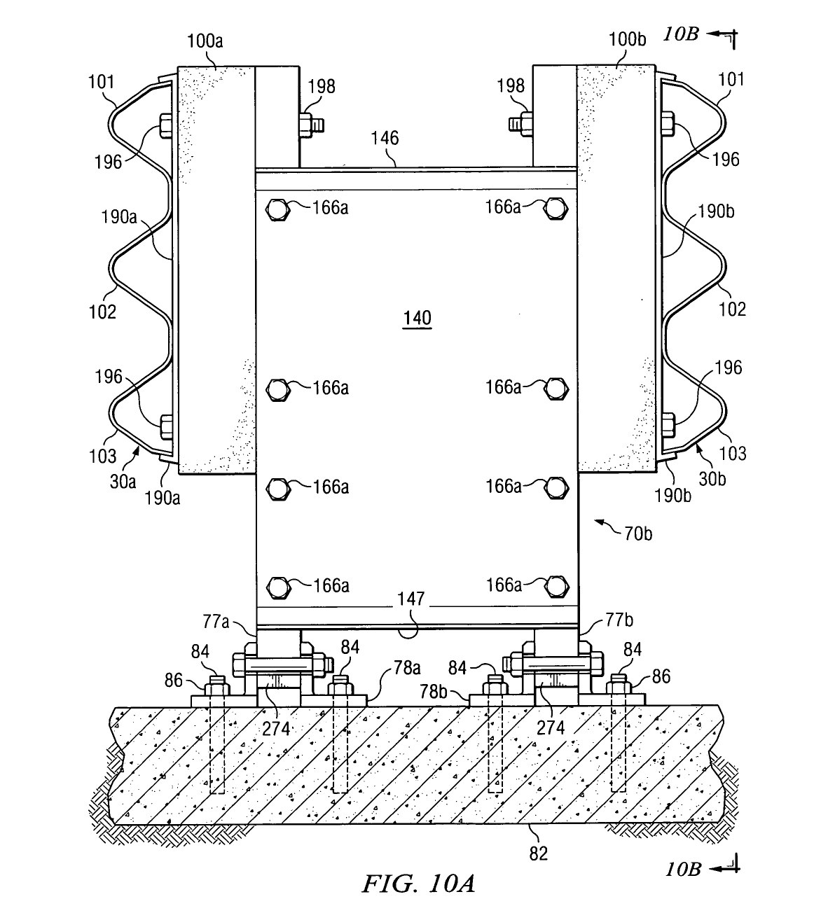

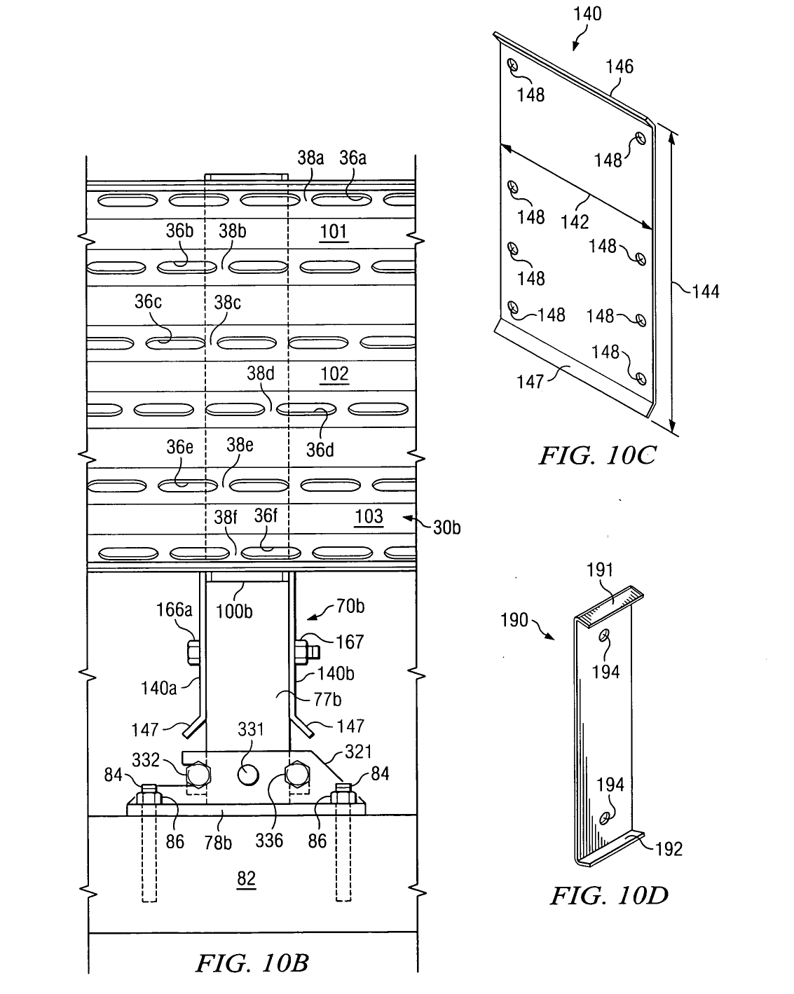

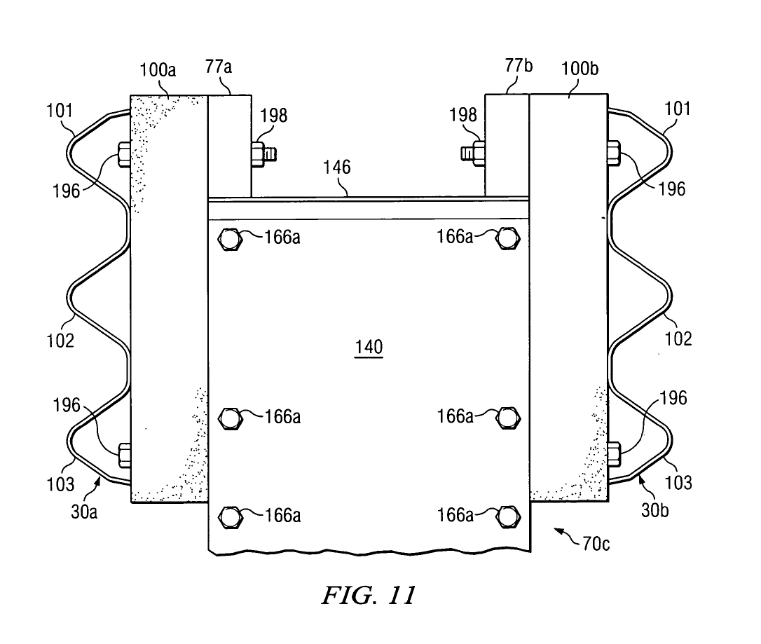

For embodiments of the present invention as shown in FIGS. 1-15B support post assemblies 70b-70f may have substantially the same overall dimensions and configuration. As discussed later in more detail, a pair of guide plates 190 may be attached to opposite sides of one or more support post assemblies 70b-70f. For example, support posts assembly 70b as shown in FIGS. 10A and 10B includes a pair of guide plates 190a and 190b. Support post assembly 70c as shown in FIG. 11 does not include a pair of guide plates.

For some applications posts 77a and 77b may be formed from respective hollow rectangular tubes 270a. See FIG. 12A. Rectangular tubes 270a may have substantially the same overall dimensions and configurations as compared with tube 270 except for second end 272. At least one diaphragm or spacer 140 may be attached with and extend between each pair of posts 77a and 77b. For the embodiment shown in FIGS. 1-15B each support post assembly 70b-70f includes a pair of diaphragm or spacers. For purposes of discussing various features of the present invention spacers 140 associated with each support post assembly 70b-70f may be designated as 140a and 140b. See FIGS. 10B and 11. Each diaphragm 140 may have a generally rectangular configuration defined in part by width 142 and height 144. See FIG. 10C. Edges 146 and 147 of diaphragms 140 may be bent at an angle to provide additional strength for each support post assembly. Width 142 of diaphragm 140 may vary between approximately two feet and four feet depending upon the desired lateral spacing between energy absorbing members 30a and 30b.

A plurality of holes 148 may be formed along opposite sides of each diaphragm 140. Corresponding holes 148 may be formed in the edge of each post 77a and 77b. See FIGS. 10C and 12A. A plurality of bolts 166a and nuts 167 may be satisfactorily used to securely engage respective pairs of diaphragms 140a and 140b with opposite edges of respective posts 77a and 77b. See FIG. 10B. Holes 149 may be formed extending through the sides of each support post 77a and 77b to accommodate attachment of respective blocks 100a and 100b using a plurality of bolts 196. See FIGS. 10A and 11.

Support post assemblies 70b-70f may also be releasably attached to respective pairs of base plates 78a and 78b. Base plates 78a and 78b preferably have substantially the same configuration and dimensions. Therefore, base plates 78b as shown in FIGS. 12A and 12B will be described in more detail.

Each base plate 78b may have a generally angular configuration defined in part by horizontal segment 312 and a vertical segment 314. Holes 216 may be formed in each horizontal segment 312 to accommodate bolts 84. Each vertical segment 314 preferably includes a first, tapered edge 321 and second edge 322 with notch 323 formed therein. The dimensions of first, tapered edge 321 may correspond with the dimensions and configuration of tapered edges 220 of base plates 76. Each vertical segment 314 may also include respective openings 324 and 326. Respective openings 324 may be formed in respective post 77a and 77b with dimensions similar to opening 324 of vertical segment 314. First bolt or positioning pin 331 may be inserted through openings 324 to position support post 77b a relative to a respective pair of base plates 78b.

Bolt 336 may be inserted through holes 336. Respective nut 338 may be engaged with each bolt 336 to is releasably engage each pair of plates 78b with post 77b. Bolts 332 may be inserted through respective notches 323 to also releasably engage a respective pairs of plates 78b with post 77b. Respective reaction bars 274 may be disposed adjacent to second end 272 of support post 77b for engagement with bolts 332 and 336. Reaction bars 274 cooperate with respective bolts 332 and 336 to allow post 77b to resist a vehicle impact with beam 22b.

During a rail face impact with respective energy absorbing members 30a and 30b, reaction bars 274 will react to forces imposed on respective posts 77a and 77b. Reaction bars 274 develop tension forces during a rail face impact to provide more uniform distribution of forces to associated base plates 78a and 78b. Support posts 77a or 77b opposite from the location of a side impact will generally experience compression forces. Also, reaction bars 274 may shear respective bolts 332 and 336 during a rail face impact to prevent damage. During a vehicle collision with impact assembly 160, reaction bars 274 will not prevent second end 272 from sliding longitudinally between respective pairs of base plates 78.

During a vehicle collision with impact assembly 160, positioning pin 331 will shear in response to impact forces. The dimensions associated with edge 321 are preferably selected to minimize potential snagging with an impacting vehicle. Notches 323 cooperate with respective bolts 332 to allow associated posts 77a and 77b to move longitudinally towards traffic barrier 130.

Respective blocks 100a and 100b may be attached on opposite sides of each support post assembly 70b-70f. See FIGS. 1, 2A, 10A and 11. Blocks 100a and 100b may be formed from composite or plastic materials with substantially the same configuration and dimension. For other applications blocks 100a and 100b may be formed from a wide variety of other materials such as wood, metal, elastomeric materials including but not limited to recycled rubber. Also, for some applications the dimensions and configurations of each block 100a and 100b may vary along the length of the associated crash cushion. For still other applications it may not be necessary to attach any blocks with the support post assembly or one block may be attached to one side of each support post assembly. Blocks 100a and 100b may be used as required to maintain desired spacing between energy absorbing members 30a and 30b. Various types of mechanical fasteners may be used to attach blocks 100a and 100b with respective post assemblies 70b-70f. The present invention is not limited to use with blocks 100a and 100b.

Energy absorbing members 30a and 30b are preferably slideably attached with support post assemblies 70b through 70f without any restraint. For some applications, guide plates 190 such as shown in FIGS. 10A and 10E may be respectively secured with blocks 100a and 100b. For this embodiment of the present invention guide plates 190 may be formed from a generally elongated rectangular sheet of metal. Ends 191 and 192 of guide plate 190 are preferably bent to form a cross section which is compatible with allowing sliding movement of energy absorbing members 30a and 30b therethrough. A plurality of holes 194 may also be formed in each guide plate 190 for use in attaching respective guide plates 190 with blocks 100a and 100b and associated parts. As shown in FIGS. 10A and 11, bolts 196 and nuts 198 may be satisfactorily used to secure a pair of guide plates 190 on opposite sides of support post assembly 70b with blocks 100a and 100b disposed therebetween.

FIG. 13 is a schematic drawing showing an elevational view of a slot and land pattern formed in energy absorbing member 30. For purposes of illustrating various features of the present invention, crowns 101, 102 and 103 are not shown in FIG. 13. For some applications absorbing member 30 may have the general configuration and dimensions associated with a typical thrie beam guardrail section. For example the location and dimensions associated with slots or openings 33, 232 and 233 may correspond with dimensions and locations of similar openings or slots associated with a conventional thrie beam guardrail section. A plurality of slots 34a-34f may be formed adjacent to second end 32 for use in slideably attaching energy absorbing members 30 with an associated beam connector 290. End 32 of each energy absorbing member 30a and 30b may be disposed on the exterior of associated beam connectors 290a and 290b overlapping corresponding crown portions 101d, 102d and 103d. A plurality of bolts 95 or other suitable shredders may be respectively disposed within slots 34a-34f of energy absorbing member 30 and respective holes 96 formed in associated beam connector 90.

A plurality of respective openings or slots 36a-36f are preferably disposed adjacent to and aligned with respective slots 34a-34f. Respective openings or slots 36a-36f extend longitudinally along beam 30. As shown in various drawings such as FIG. 10B, slots 36a and 36b may be formed in opposite sides of crown 101. Slots 36c and 36d may be formed in opposite sides of crown 102 and slots 36e and 36f in opposite sides of crown 103. A plurality of lands or metal strips respectively designated as 38a-38f are preferably disposed between each associated slot 36a-36f. An energy absorbing assembly may be formed in accordance with teachings of the present invention with one or more energy absorbing members having a wide variety of slot and land patterns. The present invention is not limited to energy absorbing members having a pattern corresponding with slots 36a-36f and lands 38a-38f. The present invention is also not limited to energy absorbing members which are formed from metal.

For the embodiment shown in FIG. 13, respective slots 36a-36f and associated lands 38a-38f may be generally described as forming a staggered offset pattern. Each set of slots 36a-36f and associated lands 38a-38f are preferably aligned with respective slots 34a-34f such that bolts 95 disposed within respective holes 96 of beam connector 290 will engage respective lands 38a-38f as energy absorbing members 30 slides longitudinally relative to beam connector 290 and end 131 of crash barrier 130.

For some applications, energy absorbing member 30 may be formed from ten (10) gauge steel alloys associated with highway guardrail systems. For other applications, energy absorbing member 30 may be formed from twelve (12) gauge steel alloys. The thickness of the material used to form energy absorbing members 30 may be varied to provide desired energy absorbing characteristics.

For some applications energy absorbing member 30 may have an overall length (l₁) may be approximately nineteen (19) feet. The longitudinal spacing (l₂) between the midpoint of slots 33 and the midpoint of slots 233 may be approximately eighteen (18) feet. The configuration, location and dimensions associated with slots 33 and slots 233 may correspond generally with a conventional thrie beam guardrail section.

The length of each land 38a-38f may vary along the length of energy absorbing member 30. For the embodiment of the present invention shown in FIG. 13, land 38f immediately adjacent to slot 34f may have a length (l₃) of approximately three-sixteenths (3/16) of an inch. Land 38f disposed adjacent to end 31 may have a length (l₄) of approximately three-eighths (⅜) of an inch. Varying the width of lands 38a-38f allows controlling deceleration of a vehicle that impacts with nose assembly 21 of crash cushion 20 or the end of crash cushion 20 facing oncoming traffic. The overall length of slots 34a-34f and respective slots 36a-36f may vary. For example, length (l₅) between slot 34f and slot 36f located proximate end 31 may be approximately seventeen feet. Slots 36a-36f may have a generally oval shaped configuration defined in part by a length of approximately three inches and a width of approximately seven-eighths of an inch. However, other slot or opening configurations may be used.

When a vehicle impacts with nose assembly 200 or the upstream end of crash cushion 20, beams 30a and 30b may move downstream relative to highway barrier 130 causing bolts 95 or other suitable shredders attached to beam connectors 290 to shred lands 38a-38f disposed between respective openings 36a-36f. In some embodiments, respective flat washers 97 may attach to two bolts 95 for shredding of lands 38a-38f. The shredding of lands 38a-38f will absorb kinetic energy of the impacting vehicle. Therefore, bolts 95 may move through slots 36a-36f until the kinetic energy of the impacting vehicle has been absorbed. According to one aspect of the invention, the staggered or offset pattern of slots 36a-36f and lands 38a-38f may be varied to minimize variations in force during absorption of the kinetic energy.

Fasteners or bolts 95 may be positioned in slots 36a-36f of beams 30a and 30b. It can be seen that if fasteners or bolts 95 and flat washers 97 are held in a fixed position while beams 30a and 30b are moved in the direction of arrow 21, bolts 95 will shred metal portions between slots 36a-36f in a continuous pattern (i.e., one bolt is shredding metal at any given time during the shredding process.)

When a vehicle impact occurs with nose assembly 200, sufficient kinetic energy may be applied to impact assembly 160 to breakaway or release support post assembly 70a. Cable anchor assemblies 50a and 50b will be released when first support post assembly 70a rotates and breaks away and move longitudinally relative to energy absorbing member 30a and 30b. Kinetic energy from the impacting vehicle may then be transferred from support post assembly 70a and impact assembly 160 to energy absorbing members 30a and 30b. Energy absorbing members 30a and 30b will telescope or move relative to first end 131 of highway barrier 130 which will initiate shredding of lands 38a-38f by bolts 95 which are securely engaged with respective beam connectors 290a and 290b. Second support post assembly 70b may also breakaway as a result of the vehicle impact. Depending upon kinetic energy associated with a vehicle impact, support post assemblies 70c-70f may also breakaway.

The staggered, offset pattern associated with slots 36a-36f and lands 38a-38f may result in sequential shredding of lands 38a-38f and increased energy absorption. As previously noted, lands 38f adjacent to slots 34a-34f may have a relatively short length which results in a relatively low amount of energy absorption as energy absorbing members 30a and 30b telescope relative to highway barrier 30. Since the length of lands 38a-38f increases from second end 32 towards first end 31, additional increments of kinetic energy may be absorbed from the impacting vehicle as energy absorbing members 30a and 30b telescope relative to highway barrier 130.

First end 91 of beam connector 290 preferably has a cross section corresponding with the cross section of associated energy absorbing members 30. Second end 92 of beam connector 290 preferably has a generally flat configuration. For the embodiment of the present invention as shown in FIG. 13, a plurality of bolts 95 may be disposed in holes 96 to securely engage beam connectors 290 with traffic barrier 130. A plurality of slots 34a-34f are provided in crowns 101, 102 and 103. Bolts or other suitable fasteners 95 may be engaged with slots 34a-34f formed adjacent to end 32 of an associated energy absorbing member 30.

An alternative configuration for slidably attaching crash cushion with highway barrier 130 is shown in FIGS. 15A and 15B. For some applications transition frame 402 may be disposed on extreme end 131 of highway barrier 130. Transition frame 402 may be formed from metal plates or other suitable materials. For some applications a pair of hollow tubes 404 and 406 may be used to securely engage beam connector 290a with side 130a adjacent to end 131 of highway barrier 130. Depending upon the configuration and design of highway barrier 130, additional tapered blocks 410 may be disposed between blocks 404 and 406 and side 130a.

Connector beam 290a may function in substantially the same manner as previously described. Shredders 95 may be securely engaged with beam connector 290a. Vehicle collision with impact assembly 120 will result in beam 22b sliding longitudinally relative to shredders 95 until the energy of the impacting vehicle has been satisfactorily dissipated.

Block 408 may be disposed on side 130b of highway barrier 130 proximate end 131. Thrie beam 430 may be securely engaged with block 408 and extend longitudinally from first end 131. For some applications blocks 406 and 408 may have similar dimensions and configurations so that second end 32 of energy absorbing member 30a and second end 32 of energy absorbing member 30b are laterally spaced approximately the same distance from highway barrier 130.

Traditional beam connector or Michigan end shoe 490 may be used to securely engage thrie beam 430 with barrier 130. One or more blocks 412 may be disposed between thrie beam 430 and side 130b. The dimensions and configurations of blocks 412 will depend upon the specific dimensions and configurations associated with highway barrier 130. Blocks 404, 406, 408 and 412 may be formed from hollow metal tubes.

Shredders 95 may be securely engaged with beam 430 proximate block 408. Respective washer 97 may also be secured with each pair of bolts 95. During a vehicle collision with impact assembly 160, beams 22a and 22b may slide longitudinally relative to transition frame 402 and first end 131 of highway barrier 130. Shredders 95 will shred lands 38 to absorb energy of the impacting vehicle as previously described.

For some applications, an energy absorbing assembly may be formed in accordance with teachings of the present invention using wooden posts (not expressly shown) which may be mounted in metal tubes (not expressly shown) to assist in breaking the wooden post at ground level. One or more holes (not expressly shown) may be formed in such wooden posts to provide desired breakaway characteristics. Posts satisfactory for use with the present invention may be made from wood or any other suitable breakaway material. The types of material which may be satisfactorily used to manufacture posts with desired strength and/or breakaway characteristics appropriate for an energy absorbing system formed in accordance with teachings of the present invention include but are not limited to wood, steel, plastic materials, composite materials and various types of plastics.

For some applications a steel foundation tube (not expressly shown) may be placed in the ground adjacent to the shoulder of a roadway (not expressly shown) at a desired location for the associated energy absorbing assembly. The posts may be inserted into respective foundation tubes. Various techniques which are well known in the art may be used to satisfactorily install foundation tubes and/or posts depending upon the type of soil conditions and other factors associated with the roadway and hazard requiring installation of the associated energy absorbing system. In addition to foundation tubes other types of post-to-ground installation systems such as concrete with steel slit base posts and direct drive breakaway posts may be satisfactorily used with an energy absorbing system incorporating teachings of the present invention.

A wide variety of support post assemblies and breakaway mechanisms may be satisfactorily used to form an energy absorbing assembly in accordance with teachings of the present invention. For some applications, a plurality of breakaway bolts may be used to attach support post assemblies with an associated foundation. For other applications, breakaway mechanisms may be used to provide satisfactory support post assemblies. The present invention is not limited to use with support post assemblies 70a -70f.

Although the present invention and its advantages have been described in detail, it should be understood that various changes, substitutions, and alterations can be made therein without departing from the spirit and scope of the invention as defined by the appended claims.

1. An energy absorbing assembly comprising:
at least two energy absorbing members extending substantially parallel with each other and spaced laterally from each other;
each energy absorbing member having a first end and a second end;
the second end of each energy absorbing member operable to be slidably attached to a traffic barrier;
a plurality of support post assemblies slideably coupled with and supporting the energy absorbing members;
the first end of the energy absorbing members securely attached with one of the support post assemblies proximate a first end of the energy absorbing assembly;
at least one of the support post assemblies having a first post and a second post spaced laterally from each other; and
a spacer coupled with and extending between the first post and the second post.

2. The energy absorbing assembly of claim 1 wherein the plurality of energy absorbing members comprises at least one thrie beam.

3. The energy absorbing assembly of claim 1 wherein the plurality of energy absorbing members comprises at least one W-beam.

4. The energy absorbing assembly of claim 1 wherein the at least one support post assembly comprises:
a spacer block attached with each post and extending laterally therefrom; and
a guide attached with each spacer block opposite from the respective post for use in guiding movement of the associated energy absorbing member relative to the respective post during dissipation of energy of an impacting vehicle.

5. The energy absorbing assembly of claim 1 further comprising an impact assembly securely coupled with the first end of each energy absorbing member.

6. The energy absorbing assembly of claim 6 wherein the impact assembly further comprises:
a striker plate having a generally rectangular configuration defined in part by a first lateral edge and a second lateral edge;
a first angle and a second angle respectively attached with the first lateral edge and the second lateral edge of the striker plate;
the angles and the striker plate securely engaged with the one support post assembly proximate the first end of the energy absorbing members; and
a respective connector securely engaging each energy absorbing member with the one support post assembly.

7. The energy absorbing assembly of claim 1 wherein the traffic barrier comprises a concrete barrier having a first end facing oncoming traffic.

8. The energy absorbing assembly of claim 1 further comprising:
a respective connector for slideably coupling the second end of each energy absorbing member with the traffic barrier; and
a plurality of shredders secured to respective connectors and registered with respective openings and lands of the energy absorbing members such that during impact of a vehicle with the first end of the energy absorbing assembly, the shredders engage the lands disposed between adjacent openings to dissipate energy of the impacting vehicle.

9. The energy absorbing assembly of claim 1 further comprising:
a first cable and a second cable attached with the one of the support post assembly proximate the first end of the energy absorbing assembly;
a first cable anchor bracket releasably attaching the first cable with one of the energy absorbing members; and
a second cable anchor bracket releasably attaching the second cable with the other energy absorbing member.

10. A crash cushion comprising:
a pair of beams spaced laterally from each other and extending substantially parallel to each other;
each beam having approximately an equal length with a first end facing oncoming traffic and a second end operable to be slideably coupled with a traffic barrier;
a first breakaway support post assembly securely attached to and supporting the first end of the beams;
an impact assembly attached to the first breakaway support post assembly proximate the first end of each beam and sized for engagement with an impacting vehicle;
additional breakaway support post assemblies disposed between the first end of the beams and the second end of the beams;
at least one support post assembly having a first post and a second post spaced laterally from each other; and
a diaphragm coupled with and extending between the first post and the second post.

11. The crash cushion of claim 10, wherein the pair of beams comprise thrie beams.

12. The crash cushion of claim 10 wherein the pair of beams comprise W-beams.

13. The crash cushion of claim 10 wherein the impact assembly further comprises:
a striker plate having a first edge and a second edge;
the striker plate securely engaged with the first support post assembly proximate the first end of the energy absorbing members; and
a respective connector securely engaging each beam with the first support post assembly.

14. The crash cushion of claim 10 further comprising:
a first cable and a second cable with each cable having a respective first end and second end;
the first end of each cable releasably anchored proximate the first end of the beams;
a first cable anchor bracket releasably attaching the second end of the first cable with one of the beams; and
a second cable anchor bracket releasably attaching the second end of the second cable with the other beam.

15. The crash cushion of claim 10 further comprising the pair of beams slideably coupled with at least one of the breakaway support post assemblies.

16. A crash cushion having an upstream end facing oncoming traffic and a downstream end disposed adjacent to a traffic barrier, the crash cushion comprising:
a nose cover at the upstream end of the crash cushion;
a plurality of energy absorbing members disposed in two beams spaced laterally from each other and extending substantially parallel to each other;
each of the energy absorbing members having a first end and a second end;
the first end of two energy absorbing members securely attached to a first breakaway support post assembly;
the second end of two energy absorbing member slideably coupled with the traffic barrier;
additional support post assemblies disposed between the first breakaway support post assembly and the traffic barrier; and
the energy absorbing members slideably coupled with at least one of the additional support post assemblies.

17. The crash cushion of claim 16 further comprising the energy absorbing members formed with a plurality of openings and lands for registration with a plurality of shredders whereby movement of the energy absorbing members with respect to the traffic barrier and the plurality of shredders results in shredding the lands to dissipate energy from an impacting vehicle.

18. The crash cushion of claim 16 wherein the additional support post assemblies further comprise breakaway support post assemblies.

19. The crash cushion of claim 16 further comprising a striker assembly securely engaged with the first breakaway support post assembly.

20. An energy absorbing assembly comprising:
a plurality of energy absorbing members extending substantially parallel with each other;
the energy absorbing assembly having a first end facing oncoming traffic and a second end slideably attached to a traffic barrier;
a plurality of breakaway support post assemblies coupled to and supporting the energy absorbing members;
one of the breakaway support post assemblies securely attached to the first end of the energy absorbing assembly facing oncoming traffic;
the energy absorbing members slideably coupled with at least one of the other breakaway support post assemblies;
a pair of guides respectively attached with opposite sides of the at least one other breakaway support post assembly; and
respective energy absorbing members slideably disposed within and supported by the guides.

21. The energy absorbing assembly of claim 20 further comprising each guide having a cross section sized to slideably receive the respective energy absorbing members therein.

22. A method of forming a crash cushion:
forming at least two beams with each beam having a first end and a second end;
forming a plurality of openings and a plurality of lands disposed between adjacent openings extending between the first end and the second end of each beam;
forming the openings and lands in respective rows aligned generally longitudinal with each other;
varying the length of the lands in each row between the first end and the second end of the beams;
positioning the first end of the beams extending from one end of a traffic barrier and facing oncoming traffic;
slideably attaching the second end of the beams with the traffic barrier using a plurality of shredders respectively aligned with each row of openings and lands; and
slideably coupling the plurality of beams with a plurality of breakaway support post assemblies spaced from the one end of the traffic barrier whereby energy from a vehicle forcefully impacting one end of the crash cushion opposite from the traffic barrier will be dissipated by the shredders shredding the lands of the beams.

23. An energy absorbing assembly comprising:
at least two energy absorbing members extending substantially parallel to one another;
each energy absorbing member includes a first end facing oncoming traffic and a second end slideably attached to a traffic barrier;
a plurality of support post assemblies coupled to and supporting the energy absorbing members;
the first end of at least two of the energy absorbing members securely attached with one of the support post assemblies proximate a first end of the energy absorbing assembly;
a plurality of shredders slideably coupling the respective second end of the energy absorbing members to the traffic barrier; and
a plurality of openings and lands formed in the energy absorbing members to encounter the plurality of shredders during impact of a vehicle with the first end of the energy absorbing assembly to dissipate energy of an impacting vehicle.

24. The energy absorbing assembly of claim 23 wherein at least one support post assembly comprises:
a first post and a second post spaced laterally from each other;
a post spacer coupled with and extending between the first post and the second post;
a spacer block attached with each post and extending laterally therefrom; and
a guide attached with each spacer block opposite from the respective post for use in guiding movement of the energy absorbing member relative to the post during dissipation of energy of the impacting vehicle.

25. The energy absorbing assembly of claim 23 further comprising an impact assembly securely coupled with the first end of the energy absorbing members.

26. An energy absorbing assembly with an impact assembly comprising:
a striker plate having a generally rectangular configuration defined in part by a first lateral edge and a second lateral edge;
a first angle and a second angle respectively attached with the first lateral edge and the second lateral edge of the striker plate;
the angles and the striker plate securely engaged with a support post assembly proximate the first end of the energy absorbing members; and
a respective connector securely engaging each energy absorbing member with the respective support post assembly.

27. The energy absorbing assembly of claim 26 further comprising:
a respective connector for slideably coupling the second end of each energy absorbing member with a traffic barrier; and
the plurality of shredders secured to respective connectors and registered with respective openings of the energy absorbing members such that during impact of a vehicle with the first end of the energy absorbing member, the shredders engage portions of the lands disposed between adjacent openings to dissipate energy of the impacting vehicle.

28-29. (Cancelled)

30. A crash cushion having an upstream end facing oncoming traffic and a downstream end disposed adjacent to a traffic barrier, the crash cushion comprising:
at least two energy absorbing members spaced laterally from each other and extending substantially parallel to each other;
each of the energy absorbing members having a first end and a second end;
the first end of the energy absorbing members securely attached to a first breakaway support post assembly;
the second end of the energy absorbing member slideably coupled with the traffic barrier;
additional support post assemblies disposed between the first breakaway support post assembly and the traffic barrier;
the energy absorbing members slideably coupled with at least one of the additional support post assemblies; and
a respective block disposed between the second end of each energy absorbing member and the traffic barrier.

31. The crash cushion of claim 30 further comprising the second end of each energy absorbing member spaced approximately an equal lateral distance from the traffic barrier.

32. A breakaway support post assembly for an energy absorbing system comprising:
a first support post and a second support post with a spacer plate disposed between and securely engaged with each support post;
each support post having a first end and a second end; and
a respective foot plate assembly releasably engaged with the second end of each support post.

33. The post assembly of claim 32 wherein each foot plate assembly further comprises:
a pair of angles with each angle having a first segment and a second segment;
a plurality of openings formed in each first segment to receive mechanical fasteners from an associated foundation;
at least one opening in each second segment for engagement proximate the second end of the respective support post; and
a shear bolt extending through the openings formed in each second segment to releasably engage the associated support post with the respective foot plate assembly.

34. The support post assembly of claim 32 wherein each support post further comprises a hollow, generally rectangular tube.

35. The breakaway support post assembly of claim 32 further comprising the spacer plate having a generally rectangular configuration with a width between approximately two feet and four feet.

36. The breakaway support post assembly of claim 32 further comprising:
the spacer plate having a generally rectangular configuration defined in part by a first edge and a second edge spaced from each other; and
the first edge and the second edge extending at an angle relative to the first support post and the second support post.

37. The breakaway support post assembly of claim 32 further comprising:
a plurality of holes formed along opposite sides of the spacer plate;
a plurality of holes formed in each support post; and
a plurality of mechanical fasteners extending through the holes to securely engage the spacer plate with the first support post and the second support post.

38. The breakaway support post assembly of claim 32 further comprising each foot plate assembly having substantially the same configuration and dimensions.

39. The breakaway support post assembly of claim 32 further comprising:
a respective pair of support plates securely attached proximate the second end of each support post; and
each foot plate assembly releasably engaged with one of the respective pairs of support plates.

40. A breakaway support post for an energy absorbing system comprising:
a generally elongated, hollow tube having a first end and a second end; and
a base plate assembly releasably engaged with the second end of the support post.

41. The breakaway support post of claim 40 wherein the base plate assembly further comprises:
a pair of angles with each angle defined in part by a horizontal segment and a vertical segment;
a plurality of holes formed in each horizontal segment to receive mechanical fasteners from an associated foundation; and
each vertical segment having at least one opening formed therein.

42. The breakaway support post of claim 41 further comprising:
each vertical segment having a first opening formed therein with dimensions corresponding to a first opening formed proximate to the second end of the support post; and
a first pin inserted through the first openings to position the support post relative to the base plate assembly.

43. The breakaway support post of claim 42 further comprising:
each vertical segment having a second opening formed therein with dimensions corresponding to a second opening formed proximate the second end of the support post; and
a first bolt inserted through the second openings and a respective nut engaged with the first bolt to releasably engage the pair of angles with the support post.

44. The breakaway support post of claim 41 further comprising:
at least one reaction bar attached to the support post proximate the second end;
each vertical segment having a first edge generally facing oncoming traffic and a second edge facing opposite from the first edge;
a notch formed in the second edge of each vertical segment with the notch having an opening opposite from the first edge;
a bolt extending through each notch proximate the reaction bar.

45. The breakaway support post of claim 40 further comprising:
a pair of support plates securely attached with the second end of the support post; and
the base plate assembly releasably engaged with the support plates.

46. The breakaway support post of claim 40 further comprising:
a pair of support plates securely attached proximate the second end of each support post;
an opening formed in each support plate;
corresponding openings formed in the base plate assembly; and
a shear bolt extending through respective openings in the base plate assembly and the support plates.
